(19) United States
(12) Patent Application Publication
(10) Pub. No.: US 2026/0145186 A1
(43) Pub. Date: May 28, 2026

(54) STEPLESS SWITCHING TOP SPRAY SHOWER AND SANITARY WARE

(71) Applicant: XIAMEN DELMEI SANITARY WARE CO., LTD., XIAMEN (CN)

(72) Inventors: Zhi ZHONG, XIAMEN (CN); Yongqiang YAN, XIAMEN (CN); Changzheng NI, XIAMEN (CN)

(73) Assignee: XIAMEN DELMEI SANITARY WARE CO., LTD., XIAMEN (CN)

(21) Appl. No.: 19/033,384

(22) Filed: Jan. 21, 2025

(30) Foreign Application Priority Data
Nov. 26, 2024 (CN) 2024117047511

(51) Int. Cl. B05B 1/16; E03C 1/04

(52) U.S. Cl. CPC B05B 1/1636; E03C 1/0408

(57) ABSTRACT

Disclosed are a stepless switching top spray shower and a sanitary ware with the same. The shower includes a switching mechanism and a driving mechanism for driving the switching mechanism to switch water channels. The switching mechanism includes: a rack connected to the driving mechanism; a gear meshing with the rack; a connecting shaft fixedly connected to the gear; and a switching disk fixedly connected to the connecting shaft and provided with a water hole. The shower further includes a sealing cover with two or more water distribution holes in communication with different water outlet channels; the driving mechanism drives the rack to move, the rack drives the gear to rotate, and the gear drives the switching disk to rotate through the connecting shaft, so that the water hole is in communication with one water distribution hole. The shower achieves stepless switching of multiple water sprays and reduces switching obstruction.

### CROSS-REFERENCE TO RELATED APPLICATIONS

The application claims priority to Chinese patent application No. 2024117047511, filed on Nov. 26, 2024, the entire contents of which are incorporated herein by reference.

### TECHNICAL FIELD

The present invention relates to the technical field of sanitary wares, in particular to a stepless switching top spray shower and a sanitary ware with the same.

### BACKGROUND

For example, Chinese invention patent documents CN105728210B and CN105583094B disclose a water channel switching mechanism, where a ratchet wheel and ratchet tooth transmission mechanism is used as a core structure for water channel switching, an external driving mechanism drives ratchet teeth to rotate, the ratchet teeth drive a ratchet wheel to rotate, then a rotating water distribution disk is driven to rotate, and the rotating water distribution disk connects a water inlet chamber of a water distribution seat to one water outlet channel, thereby achieving the switching of different water outlet channels.

The ratchet wheel is an intermittent motion mechanism that converts linear reciprocating motion or rotational motion into unidirectional step motion. On the one hand, the transmission of the ratchet wheel and the ratchet teeth relies on precise meshing between the teeth on the ratchet wheel and tooth sockets on a pawl, so inappropriate meshing clearance may incur switching obstruction. On the other hand, the requirements for the manufacturing and assembly precision of the ratchet wheel and the pawl are high, so machining errors or improper assembly may incur uneven meshing, resulting in unsmooth switching. On another hand, a spring is usually required to maintain the contact between the pawl and the ratchet wheel, so uneven or insufficient spring force may disenable the pawl to stably mesh with the ratchet teeth, resulting in instable switching.

### SUMMARY

To solve the above problems, the present invention provides a stepless switching top spray shower and a sanitary ware. The top spray shower achieves stepless switching of diverse water sprays and reduces switching obstruction by using a combination of a gear rack transmission mechanism and a switching disk.

To achieve the above objective, the technical solution adopted by the present invention is as follows:

A stepless switching top spray shower, including a driving mechanism (20) and a switching mechanism (30), the driving mechanism (20) being used for driving the switching mechanism (30) to switch water channels, where the switching mechanism (30) includes:
a rack (31) connected to the driving mechanism (20);
a gear (32) meshing with the rack (31);
a connecting shaft (33) fixedly connected to the gear (32); and
a switching disk (34) fixedly connected to the connecting shaft (33);
the top spray shower further includes a sealing cover (40); the switching disk (34) is provided with a water hole (341), the sealing cover (40) is provided with two or more water distribution holes (41), and each water distribution hole (41) is in communication with a different water outlet channel; the driving mechanism (20) drives the rack (31) to move, the rack (31) drives the gear (32) to rotate, and the gear (32) drives the switching disk (34) to rotate through the connecting shaft (33), so that the water hole (341) is in communication with one of the water distribution holes (41).

Preferably, the top spray shower further includes a shower body (10), and the shower body (10) is provided with a fixing seat (12); the rack (31) is mounted on the fixing seat (12) in a sliding manner, and the gear (32) is rotatably mounted on the fixing seat (12).

Preferably, the fixing seat (12) is provided with a sliding rail or a sliding groove, a first side of the rack is connected to the driving mechanism (20), and a second side of the rack is connected to the sliding rail or the sliding groove by sliding fit.

Preferably, the driving mechanism (20) is a push button, the rack (31) is provided with an insertion hole (311), and an insertion rod of the push button is in insertion fit with the insertion hole (311).

Preferably, a ball (11) is provided at a water inlet end of the fixing seat (12), a water outlet chamber is provided at a water outlet end, and a sealing piece (13) is provided in the water outlet chamber; the water hole (341) of the switching disk (34) is in communication with the water outlet chamber.

Preferably, the water distribution cover (50) is provided on the water outlet channels, and a first water distribution chamber (52) and a second water distribution chamber (53) are formed on an upper side and a lower side of the water distribution cover (50) respectively; when the rack (31) and the gear (32) are in a first meshing position, water flows into the first water distribution chamber (52) via one of the water distribution holes and then flows out via a water outlet hole (61) to form first state water; when the rack (31) and the gear (32) are in a second meshing position, water flows into the second water distribution chamber (52) via other one of the water distribution holes and then flows out via the water outlet hole (61) to form second state water.

Preferably, the water distribution cover (50) is provided with a water hole (51), and the water from the first water distribution chamber (52) enters the second water distribution chamber (53) via the water hole (51).

Preferably, the top spray shower further includes a water outlet body (60), the water outlet hole (61) is formed on the water outlet body (60), and the water outlet hole (61) is misaligned with the water hole (51), so that the water in the water hole (51) enters the water outlet hole (61) after rotation.

Preferably the top spray shower further includes a decorative cover (70), the decorative cover (70) is provided with a water outlet yield hole (71), the quantity and position of the water outlet yield hole (71) correspond to those of the water outlet hole (61), and the diameter of the water outlet yield hole (71) is greater than that of the water outlet hole (61).

The present invention further provides a sanitary ware, including the stepless switching top spray shower described in any of the above.

Beneficial effects of the present invention are as follows:
(1) The driving mechanism drives the rack to move, the gear meshing with the rack is driven to rotate, and then the switching disk is driven to rotate through the connecting shaft. The combination design of the gear rack transmission mechanism and the switching disk achieves smooth and stepless switching between multiple water spray modes, effectively reduces obstruction in the switching process, and improves user experience.
(2) The rack is mounted on the fixing seat in a sliding manner, and the gear is rotatably mounted on the fixing seat, so that the entire switching mechanism is stable in structure and operates smoothly. Meanwhile, the design of the sliding rail or the sliding groove further enhances the stability of rack movement, and ensures the accuracy of switching.
(3) The switching disk is provided with a water hole, the sealing cover is provided with a plurality of water distribution holes, and each water distribution hole is in communication with a different water outlet channel. By the rotation of the switching disk, the water outlet is in communication with different water distribution holes, thereby achieving the switching of multiple water outlet modes, with a simple structure and easy operation.
(4) The gear drives a central shaft and the switching disk, which allows water to flow out in different ways through upper and lower spaces, to achieve diverse water sprays from one hole.
(5) The switching mechanism provides smoother force transmission because the gear meshing is more uniform than a ratchet wheel and ratchet teeth, and can provide a more accurate transmission ratio to reduce switching obstruction and unsmoothness.
(6) The switching mechanism has high transmission efficiency, requires less force when switching water channels, and is easier to operate.

### BRIEF DESCRIPTION OF DRAWINGS

The accompanying drawings described herein are intended to provide a further understanding of the present invention and form a part of the present invention. The illustrative embodiments of the present invention and the descriptions thereof are used for explaining the present invention and do not constitute undue limitation of the present invention.

FIG. 1 is a bottom view of a stepless switching top spray shower according to a first embodiment of the present invention;

FIG. 2 is a front view of the stepless switching top spray shower according to the first embodiment of the present invention;

FIG. 3 is an exploded structural view of the stepless switching top spray shower according to the first embodiment of the present invention;

FIG. 4 is a schematic view of a first meshing state of the stepless switching top spray shower according to the first embodiment of the present invention;

FIG. 5 is a cross-sectional structural view of a first water outlet function corresponding to the first meshing state of the stepless switching top spray shower according to the first embodiment of the present invention;

FIG. 6 is a schematic view of a second meshing state of the stepless switching top spray shower according to the first embodiment of the present invention;

FIG. 7 is a cross-sectional structural view of a second water outlet function corresponding to the second meshing state of the stepless switching top spray shower according to the first embodiment of the present invention;

FIG. 8 is a schematic structural view of a sealing cover of a stepless switching top spray shower according to a second embodiment of the present invention;

FIG. 9 is a schematic view of a first water outlet function of the stepless switching top spray shower according to the second embodiment of the present invention;

FIG. 10 is a schematic view of a second water outlet function of the stepless switching top spray shower according to the second embodiment of the present invention; and

FIG. 11 is a schematic view of a third water outlet function of the stepless switching top spray shower according to the second embodiment of the present invention.

### LIST OF REFERENCE NUMERALS

10—shower body; 101—ball mounting port; 102—push button mounting port;
11—ball; 111—nut; 112—C ring; 113—spherical pad;
12—fixing seat; 121—gear seat; 122—sliding rail; 123—ball seat; 124—screw;
13—sealing piece;
20—driving mechanism (push button);
30—switching mechanism; 31—rack; 311—insertion hole; 312—sliding groove; 32 gear; 33—connecting shaft; 331—connecting shaft sealing ring; 34—switching disk; 341—water hole; 342—switching disk sealing ring
40—sealing cover; 41—water distribution hole;
50—water distribution cover; 51—water hole; 52—first water distribution chamber; 53—second water distribution chamber;
60—water outlet body; 61—water outlet hole

70—decorative cover; 71—water outlet yield hole.

### DETAILED DESCRIPTION OF THE EMBODIMENTS

In order to make the technical problems to be solved, technical solutions and advantages of the present invention clearer, the present invention will be further described in detail below in conjunction with the accompanying drawings and embodiments. It should be understood that the specific embodiments described herein are merely used for interpreting the present invention, rather than limiting the present invention.

### First Embodiment (Dual Channel Switching)

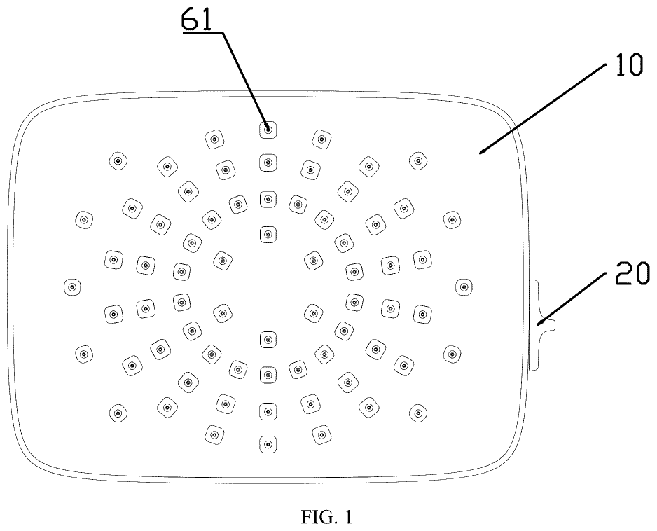

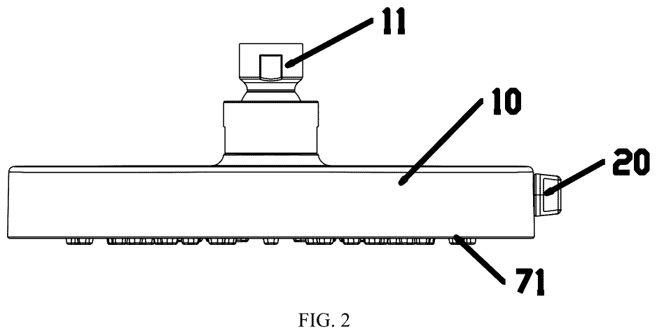

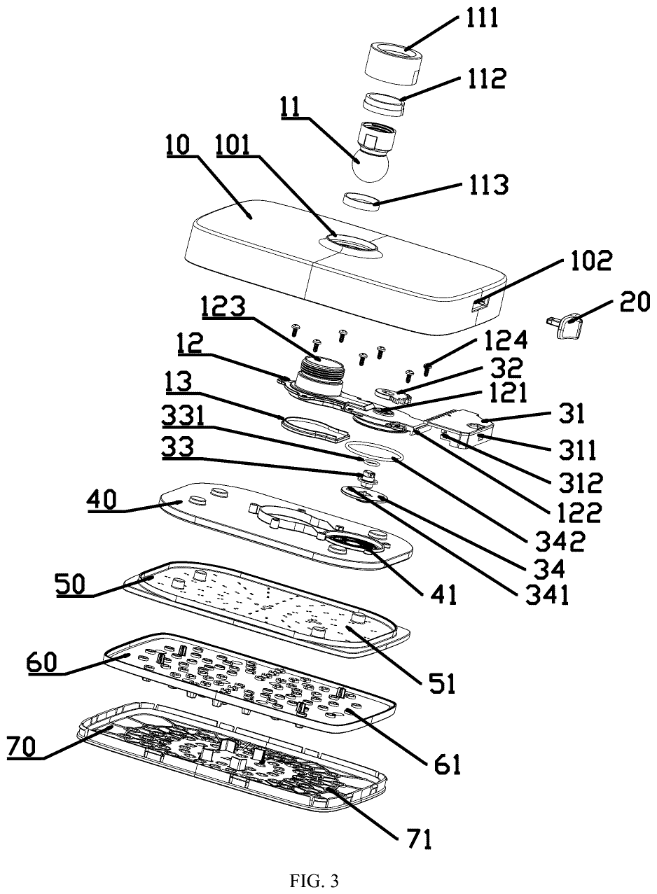

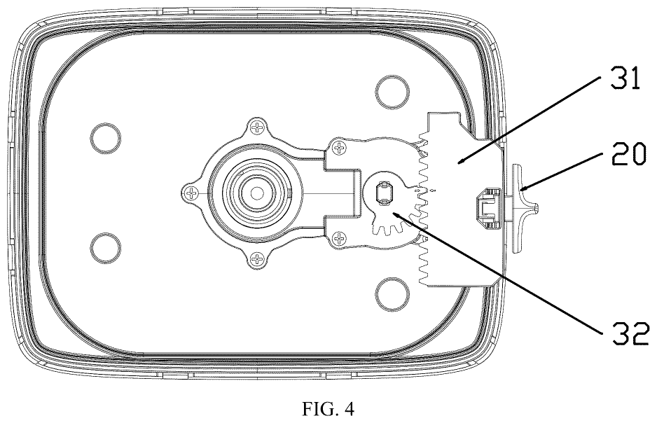

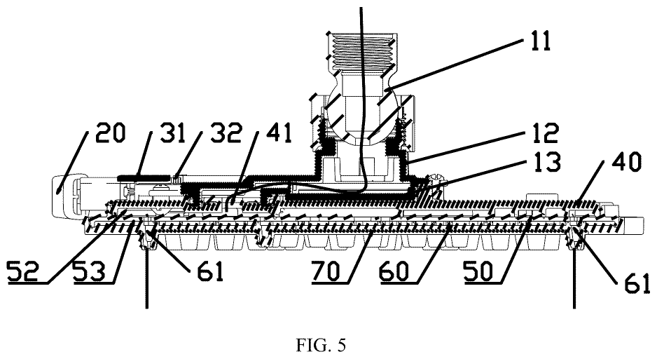

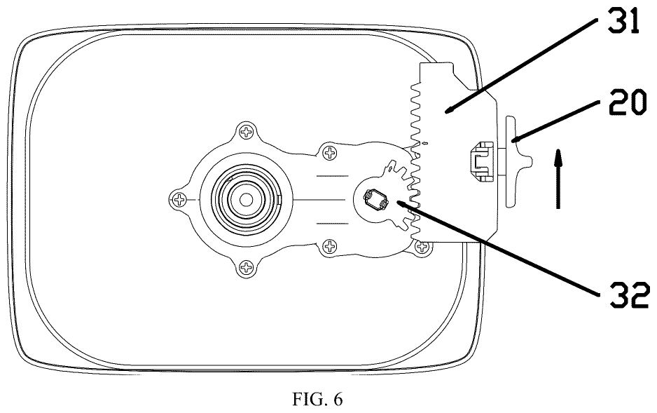

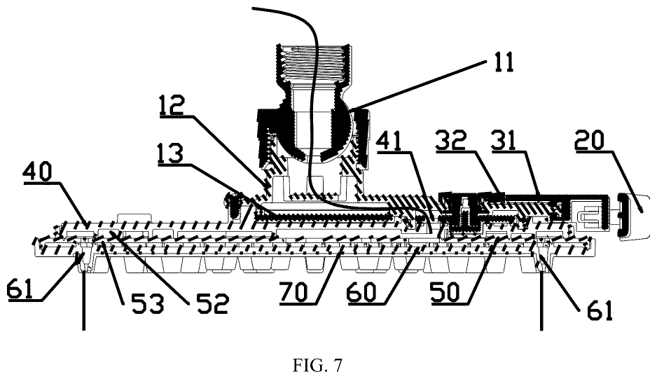

As shown in FIG. 1 to FIG. 7, a stepless switching top spray shower in the present invention includes a driving mechanism 20 and a switching mechanism 30, the driving mechanism 20 being used for driving the switching mechanism 30 to switch water channels, where the switching mechanism 30 includes:
a rack 31 connected to the driving mechanism 20;
a gear 32 meshing with the rack 31;
a connecting shaft 33 fixedly connected to the gear 32; and
a switching disk 34 fixedly connected to the connecting shaft 33;
the top spray shower further includes a sealing cover 40; the switching disk 34 is provided with a water hole 341, the sealing cover 40 is provided with two or more water distribution holes 41, and each water distribution hole 41 is in communication with a different water outlet channel; the driving mechanism 20 drives the rack 31 to move, the rack 31 drives the gear 32 to rotate, and the gear 32 drives the switching disk 34 to rotate through the connecting shaft 33, so that the water hole 341 is in communication with one of the water distribution holes 41.

In this embodiment, the connecting shaft 33 is connected to the gear 32 in a sealing manner through a connecting shaft sealing ring 331; the switching disk 34 is connected to the sealing cover 40 in a sealing manner through a switching disk sealing ring 342 or a sealing gasket.

In this embodiment, the top spray shower further includes a shower body 10, a water distribution cover 50, a water outlet body 60, and a decorative cover 70, where the water distribution cover 50 and the water outlet body 60 are in insertion fit, and the water outlet body 60 and the decorative cover 70 are in insertion fit; the insertion fit involves an insertion slot provided on one of the two and an insertion post on other one of the two.

### Shower Body 10

The shower body 10 is provided with a fixing seat 12, the fixing seat 12 is locked and fixed to the shower body 10 by screws 124; the rack 31 is mounted on the fixing seat 12 in a sliding manner, and the gear 32 is rotatably mounted on the fixing seat 12. The fixing seat 12 is provided with a sliding rail or a sliding groove, a first side of the rack is connected to the driving mechanism 20, and a second side of the rack is connected to the sliding rail or the sliding groove by sliding fit. In this embodiment, a sliding rail 122 is provided on the fixing seat 12, a sliding groove 312 is correspondingly provided on the rack 31, the sliding rail 122 is I-shaped, the sliding groove 312 is C-shaped, the two are nested and in sliding fit with each other, and their sliding distance is limited by an inner wall of the shower body 10.

A ball 11 is provided at a water inlet end of the fixing seat 12, and the ball 11 is connected to the shower body 10 in a sealing manner through a spherical pad 113; a water outlet chamber is provided at the water outlet end, and a sealing piece 13 is provided in the water outlet chamber; the water hole 341 of the switching disk 34 is in communication with the water outlet chamber. In this embodiment, the sealing piece 13 is embedded in the sealing cover 40, the sealing cover 40 is provided with a vertical wall that matches the shape of the sealing piece 13, and the vertical wall is used for forming the water outlet chamber.

In this embodiment, the shower body 10 is further provided with a ball mounting port 101, and the ball 11 passes through the ball mounting port 101 and is locked and connected to a ball seat 123 on the fixing seat 12 by a nut 111.

The driving mechanism 20 is a push button, the shower body 10 is further provided with a push button mounting port 102, the rack 31 is provided with an insertion hole 311, and an insertion rod of the push button passes through the push button mounting port 102 and then is in insertion fit with the insertion hole 311.

### Water Distribution Cover 50

In this embodiment, the water distribution cover 50 is provided on the water outlet channels, and a first water distribution chamber 52 and a second water distribution chamber 53 are formed on an upper side and a lower side of the water distribution cover 50 respectively; when the rack 31 and the gear 32 are in a first meshing position, water flows into the first water distribution chamber 52 via one of the water distribution holes and then flows out via a water outlet hole 61 to form first state water; when the rack 31 and the gear 32 are in a second meshing position, water flows into the second water distribution chamber 52 via other one of the water distribution holes and then flows out via the water outlet hole 61 to form second state water. In this embodiment, the first state water is shower water, the second state water is granular water, and the first state water and the second state water flow out via the same water outlet hole 61.

The water distribution cover 50 is provided with a water hole 51, and the water from the first water distribution chamber 52 enters the second water distribution chamber 53 via the water hole 51.

### Water Outlet Body 60

In this embodiment, the water outlet body 60 is further provided on the water outlet channels, the water outlet hole 61 is formed on the water outlet body 60, and the water outlet hole 61 is misaligned with the water hole 51, so that the water in the water hole 51 enters the water outlet hole 61 after rotation. Preferably, an arc-shaped guide groove is further provided between the water hole 51 and the water outlet hole 61, and the arc-shaped guide groove may be arranged on the side of the water outlet cover 50 facing the water outlet body 60, or on the side of the water outlet body 60 facing the water outlet cover 50.

### Decorative Cover 70

The decorative cover 70 is provided with a water outlet yield hole 71, the quantity and position of the water outlet yield hole 71 correspond to those of the water outlet hole 61, and the diameter of the water outlet yield hole 71 is greater than that of the water outlet hole 61. Preferably, the decorative cover is provided with a coating or made of soft rubber.

It should be noted that the structures and connection methods of the water distribution cover 50, the water outlet body 60, and the decorative cover 70 may be designed by existing technologies, which will not be elaborated here.

### Second Embodiment (Three-Channel Switching)

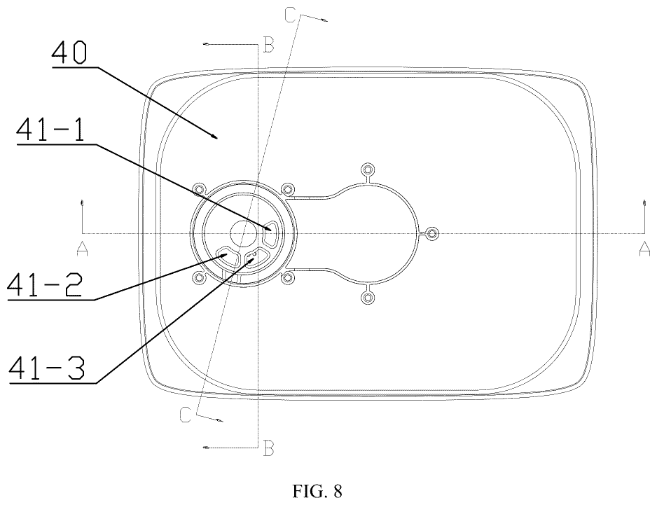

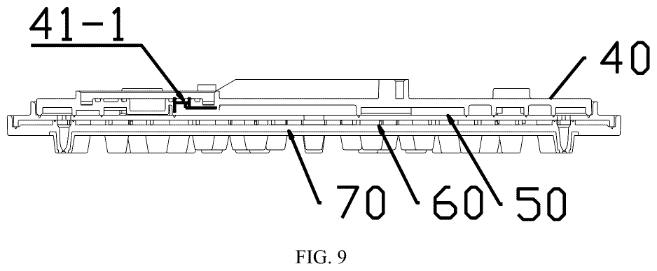

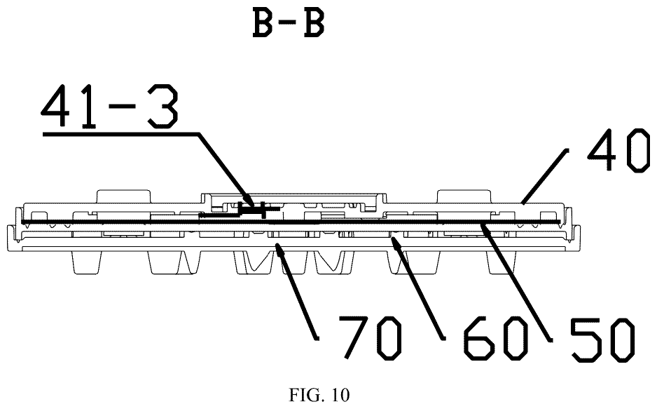

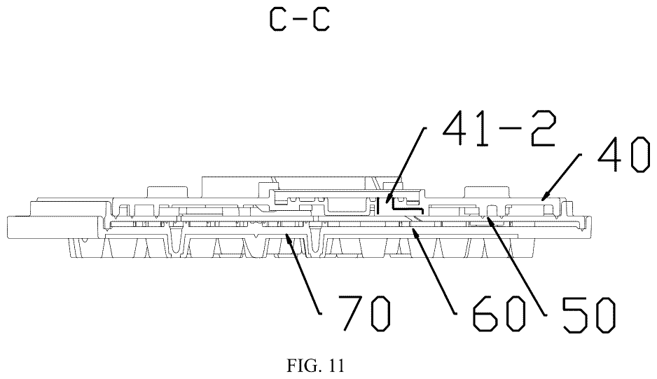

As shown in FIG. 8 to FIG. 11, this embodiment mainly differs from the first embodiment in that, in this embodiment, the sealing cover 40 is provided with three water distribution holes, including a first water distribution hole 41-1, a second water distribution hole 41-2, and a third water distribution hole 41-3, each of which is in communication with a different water outlet channel. For example:

The push button drives the rack 31 to drive the gear 32, and the gear 32 drives the switching disk 34 to rotate through the connecting shaft 33. When the water hole 341 of the switching disk 34 rotates to the first water distribution hole 41-1, granular water flows out via the first outlet channel; when the water hole 341 of the switching disk 34 rotates to the second water distribution hole 41-2, shower water flows out via the second outlet channel; when the water hole 341 of the switching disk 34 rotates to the third water distribution hole 41-3, pulse massage water flows out via the third outlet channel.

Similarly, according to the needs of specific application scenarios, a plurality of water distribution holes 41 may be added to the sealing cover 40, so that when the rack 31 and the gear 32 are in different meshing positions, the switching disk 34 is in communication with different water distribution holes 41, and the water distribution holes 41 are further in communication with different water outlet channels to achieve different water outlet functions. The structural design of the water outlet channels may be implemented by existing technologies, which will not be illustrated one by one here.

### Third Embodiment (Sanitary Ware)

The present invention further provides a sanitary ware, including the stepless switching top spray shower described in the first or second embodiment. The sanitary ware includes but is not limited to shower rooms, shower systems, shower columns, bathtubs, toilets, etc.

The above explanation illustrates and describes the preferred embodiments of the present invention. It should be understood that the present invention is not limited to the form disclosed herein, should not be regarded as an exclusion of other embodiments, can apply to various other combinations, modifications and environments, and can be modified within the scope of conception of the present invention through the foregoing teachings or technologies or knowledge in related fields. Any modifications and changes made by those skilled in the art without departing from the spirit and scope of the present invention should fall within the protection scope of the appended claims of the present invention.

What is claimed is:

1. A stepless switching top spray shower, comprising a driving mechanism (20) and a switching mechanism (30), the driving mechanism (20) being used for driving the switching mechanism (30) to switch water channels, wherein the switching mechanism (30) comprises:
a rack (31) connected to the driving mechanism (20);
a gear (32) meshing with the rack (31);
a connecting shaft (33) fixedly connected to the gear (32); and
a switching disk (34) fixedly connected to the connecting shaft (33);
the top spray shower further comprises a sealing cover (40); the switching disk (34) is provided with a water hole (341), the sealing cover (40) is provided with two or more water distribution holes (41), and each water distribution hole (41) is in communication with a different water outlet channel; the driving mechanism (20) drives the rack (31) to move, the rack (31) drives the gear (32) to rotate, and the gear (32) drives the switching disk (34) to rotate through the connecting shaft (33), so that the water hole (341) is in communication with one of the water distribution holes (41).

2. The stepless switching top spray shower according to claim 1, further comprising a shower body (10), wherein the shower body (10) is provided with a fixing seat (12); the rack (31) is mounted on the fixing seat (12) in a sliding manner, and the gear (32) is rotatably mounted on the fixing seat (12).

3. The stepless switching top spray shower according to claim 2, wherein the fixing seat (12) is provided with a sliding rail or a sliding groove, a first side of the rack is connected to the driving mechanism (20), and a second side of the rack is connected to the sliding rail or the sliding groove by sliding fit.

4. The stepless switching top spray shower according to claim 3, wherein the driving mechanism (20) is a push button, the rack (31) is provided with an insertion hole (311), and an insertion rod of the push button is in insertion fit with the insertion hole (311).

5. The stepless switching top spray shower according to claim 2, wherein a ball (11) is provided at a water inlet end of the fixing seat (12), a water outlet chamber is provided at a water outlet end, and a sealing piece (13) is provided in the water outlet chamber; the water hole (341) of the switching disk (34) is in communication with the water outlet chamber.

6. The stepless switching top spray shower according to claim 1, wherein the water distribution cover (50) is provided on the water outlet channels, and a first water distribution chamber (52) and a second water distribution chamber (53) are formed on an upper side and a lower side of the water distribution cover (50) respectively; when the rack (31) and the gear (32) are in a first meshing position, water flows into the first water distribution chamber (52) via one of the water distribution holes and then flows out via a water outlet hole (61) to form first state water; when the rack (31) and the gear (32) are in a second meshing position, water flows into the second water distribution chamber (52) via other one of the water distribution holes and then flows out via the water outlet hole (61) to form second state water.

7. The stepless switching top spray shower according to claim 6, wherein the water distribution cover (50) is provided with a water hole (51), and the water from the first water distribution chamber (52) enters the second water distribution chamber (53) via the water hole (51).

8. The stepless switching top spray shower according to claim 7, further comprising a water outlet body (60), wherein the water outlet hole (61) is formed on the water outlet body (60), and the water outlet hole (61) is misaligned with the water hole (51), so that the water in the water hole (51) enters the water outlet hole (61) after rotation.

9. The stepless switching top spray shower according to claim 8, further comprising a decorative cover (70), wherein the decorative cover (70) is provided with a water outlet yield hole (71), the quantity and position of the water outlet yield hole (71) correspond to those of the water outlet hole (61), and the diameter of the water outlet yield hole (71) is greater than that of the water outlet hole (61).

10. A sanitary ware, comprising the stepless switching top spray shower according to claim 1.

11. A sanitary ware, comprising the stepless switching top spray shower according to claim 2.

12. A sanitary ware, comprising the stepless switching top spray shower according to claim 3.

13. A sanitary ware, comprising the stepless switching top spray shower according to claim 4.

14. A sanitary ware, comprising the stepless switching top spray shower according to claim 5.

15. A sanitary ware, comprising the stepless switching top spray shower according to claim 6.

16. A sanitary ware, comprising the stepless switching top spray shower according to claim 7.

17. A sanitary ware, comprising the stepless switching top spray shower according to claim 8.

18. A sanitary ware, comprising the stepless switching top spray shower according to claim 9.
